(19) United States
(12) Patent Application Publication
(10) Pub. No.: US 2021/0396710 A1
(43) Pub. Date: Dec. 23, 2021

(54) MONITORING SYSTEM FOR ELECTROCHEMICAL SENSOR AND MONITORING METHOD OF ELECTROCHEMICAL SENSOR

(71) Applicant: Endress+Hauser Conducta GmbH+Co. KG, Gerlingen (DE)

(72) Inventors: Bo Ottersten, Regensburg (DE); Hans-Peter Roesler, Tübingen (DE)

(21) Appl. No.: 17/351,848

(22) Filed: Jun. 18, 2021

(30) Foreign Application Priority Data
Jun. 18, 2020 (DE) 10 2020 116 179.4

(51) Int. Cl. G01N 27/416; G01N 27/30

(52) U.S. Cl. CPC G01N 27/4167; G01N 27/302

(57) ABSTRACT

The present disclosure relates to a monitoring system for an electrochemical sensor, comprising: a first measuring point having a first measuring medium, a first electrochemical sensor that is in contact with the first measuring medium and is suitable for generating first sensor data, an electronic unit which is connected to the first electrochemical sensor and has a data memory, the electronic unit being suitable for storing the first sensor data generated by the first electrochemical sensor in the data memory, a computing unit adapted to be connected to the electronic unit for reading out the first sensor data in the data memory, the computing unit being connected to a database and the database having second sensor data of second electrochemical sensors, the second electrochemical sensors being structurally identical to the first electrochemical sensor.

### CROSS-REFERENCE TO RELATED APPLICATION

The present application is related to and claims the priority benefit of German Patent Application No. 10 2020 116 179.4, filed on Jun. 18, 2020, the entire contents of which are incorporated herein by reference.

### TECHNICAL FIELD

The present disclosure relates to a monitoring system for an electrochemical sensor and to a monitoring method of an electrochemical sensor.

### BACKGROUND

In analytical measurement technology, in the fields of water management, environmental analysis and in industry, for example in food technology, biotechnology and pharmaceuticals, as well as for various laboratory applications, measurands, such as the pH value, the conductivity or the concentration of analytes, such as ions or dissolved gases in a gaseous or liquid measurement medium, are of great importance. These measurands can be recognized and/or monitored, for example, by means of electrochemical sensors, such as optical, potentiometric, amperometric, voltammetric or coulometric sensors, or even conductivity sensors.

However, electrochemical sensors are subject to aging, which depends on the conditions of use and the time of use of an electrochemical sensor. This aging is also called drift, since aging causes a change, i.e. drift, in the measured values determined by the electrochemical sensor. In order to correct the drift of an electrochemical sensor, it must be calibrated at fixed intervals. If the drift of the electrochemical sensor cannot be corrected by a calibration, the failed sensor has to be replaced.

In operation, precipitation of an electrochemical sensor is to be avoided under all circumstances in order to minimize downtimes in production runs. For this reason, a prognosis of the failure time of the electrochemical sensor is of great importance. It is also desirable to minimize the calibrations of the electrochemical sensor in order to minimize maintenance work and downtimes of production runs.

Solutions are known in the prior art, in particular from DE 102016118544 A1, in order to predict a remaining service life of an electrochemical sensor. However, this prediction has only limited accuracy.

### SUMMARY

It is therefore an object of the present disclosure to enable a prediction of the remaining service life of an electrochemical sensor, which is of highest accuracy.

This object is achieved according to the present disclosure by a monitoring system method according to claim 1.

The monitoring system according to the present disclosure for an electrochemical sensor comprises: a first measuring point having a first measuring medium, a first electrochemical sensor in contact with the first measurement medium and adapted to generate first sensor data, an electronic unit connected to the first electrochemical sensor and having a data memory, wherein the electronic unit is suitable for storing the first sensor data generated by the first electrochemical sensor in the data memory, a computing unit adapted to be connected to the electronic unit to read out the first sensor data in the data memory, wherein the computing unit is connected to a database, and the database comprises second sensor data of second electrochemical sensors, the second electrochemical sensors being structurally identical to the first electrochemical sensor, the second sensor data being generated by the second electrochemical sensors at second measuring points different from the first measuring point in second measuring media different from the first measuring medium, wherein the computing unit is suitable for comparing the first sensor data with the second sensor data and, based on a deviation of the first sensor data from the second sensor data, for predicting the remaining service life and/or the next calibration time of the first electrochemical sensor.

The monitoring system according to the present disclosure makes it possible to access an unlimited number of sensor data of electrochemical sensors at other measuring points with comparable measuring conditions in order to determine a maximum exact prediction of the remaining service life and/or the next calibration time. It is thus possible to use information from all produced structurally identical electrochemical sensors, in particular external sensors which have collected sensor data under quasi identical measuring conditions, in order to predict the remaining service life of an electrochemical sensor. If the measurement conditions of the first sensor data are identical to the measurement conditions of the second sensor data, an identical course of the service life and the calibration cycles between the first electrochemical sensor and the second electrochemical sensors can be expected. Thus, based on a large data set of past, past sensor behavior can be inferred from other measuring points to the expected course of the sensor to be examined. Service life prediction and calibration prediction can thereby be optimized.

In one embodiment of the present disclosure, the second sensor data are generated by a plurality of second electrochemical sensors.

In one embodiment of the present disclosure, the database is a central cloud or a decentralized film, and the second sensor data is anonymised.

In one embodiment of the present disclosure, the first electrochemical sensor is a pH sensor, a disinfection sensor or a dissolved oxygen sensor.

In one embodiment of the present disclosure, the second electrochemical sensors are external sensors.

In one embodiment of the present disclosure, the second sensor data were respectively generated under the same measurement conditions as the measurement conditions under which the first electrochemical sensor produced the first sensor data.

The object according to the present disclosure is also achieved by a monitoring method according to claim 6.

The electrochemical sensor monitoring method according to the present disclosure comprises the following steps: providing a monitoring system according to the present disclosure, generating first sensor data by the first electrochemical sensor, storing the first sensor data in the data memory of the electronic unit, connecting the electronic unit to the computing unit, reading out the first sensor data from the data memory through the computing unit, reading out the second sensor data from the database through the computing unit, comparing the first sensor data with the second sensor data through the computing unit, determining a deviation of the first sensor data from the second sensor data, establishing a prediction of the remaining service life and/or the next calibration time of the first electrochemical sensor based on the determined deviation.

In one embodiment of the present disclosure, the first sensor data and the second sensor data comprise a history of analyte values, zero point values, slope values, asymmetry values, impedance values, load values or residual service life.

The electrochemical sensor monitoring method according to the present disclosure comprises the following steps: providing a monitoring system according to the present disclosure, generating first sensor data by the first electrochemical sensor, storing the first sensor data in the data memory of the electronic unit, connecting the electronic unit to the database, sending the first sensor data from the electronic unit to the database, reading out the first sensor data from the database through the computing unit, reading out the second sensor data from the database through the computing unit, comparing the first sensor data with the second sensor data through the computing unit, determining a deviation of the first sensor data from the second sensor data, establishing a prediction of the remaining service life and/or the next calibration time of the first electrochemical sensor based on the determined deviation.

According to one embodiment of the present disclosure, the next calibration time is indicated as immediately pending if the deviation exceeds a first limit.

According to one embodiment of the present disclosure, if the next calibration time determined by the deviation is further away than a next calibration time specified by the user, an extension of the predetermined next calibration time to the ascertained next calibration time is proposed.

### BRIEF DESCRIPTION OF THE DRAWINGS

The present disclosure will be explained in more detail on the basis of the following description of the figures. The following are shown:

FIG. 1 is a schematic depiction of a monitoring system according to the present disclosure,

FIG. 2 is an exemplary illustration of a course of the sensor data of various electrochemical sensors.

### DETAILED DESCRIPTION

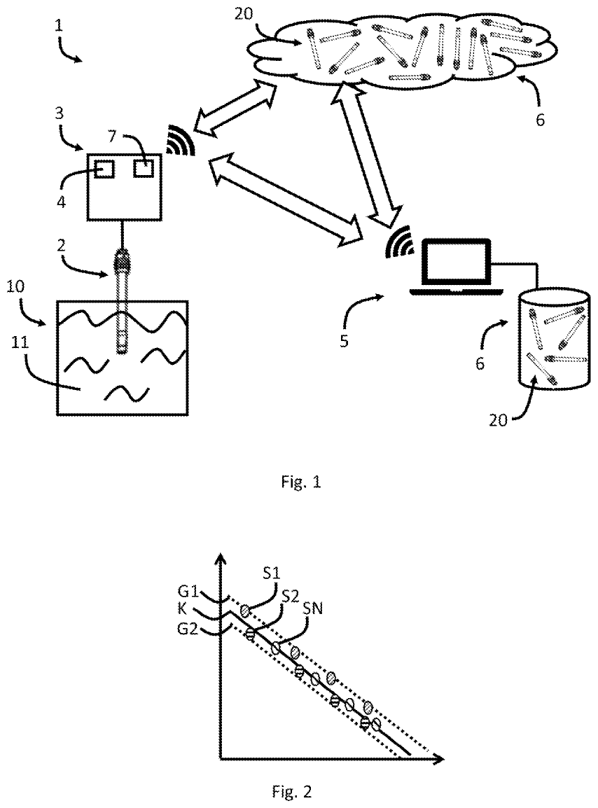

FIG. 1 shows the monitoring system 1 according to the present disclosure with a first electrochemical sensor 2, an electronic unit 3 and a computing unit 5.

The first electrochemical sensor 2 is, for example, a pH sensor, a disinfection sensor, a chlorine sensor, a chlorine dioxide sensor, a bromine sensor or a dissolved oxygen sensor.

The term sensor data is understood below to mean: Measured values of a measurement, for example a pH value, a chlorine content, a chlorine dioxide content, a bromine content or an oxygen content of the measured medium, analyte values, zero point values, impedance values, slope values, asymmetry values, load values or values with respect to a remaining service life of a sensor. How the load values or the remaining service life is determined is disclosed in the publication cited at the beginning, to which full reference is made here.

The first electrochemical sensor 2 is adapted to generate first sensor data S1. Depending on the sensor type of the first electrochemical sensor 2 the first sensor data S1 comprise measured values of a measurement, for example a pH value, a chlorine content, a chlorine dioxide content, a bromine content or an oxygen content of the measured medium. The first sensor data S1 further comprises a history of analyte values, zero point values, impedance values, slope values, asymmetry values, load values, values regarding a remaining service life of the first electrochemical sensor 2, the measurement conditions of the first electrochemical sensor 2, or information regarding the sensor type, such as the design or sensor model, the serial number, the measurement duration, the number of calibration cycles, the service life, the date of production of the sensor, and/or the date of initial start-up of the sensor.

The first electrochemical sensor 2 is connected to the electronic unit 3 in order to forward the generated first sensor data S1 to the electronic unit 3. The first electrochemical sensor 2 is preferably supplied with electrical energy by the electronic unit 3.

The electronic unit 3 is, for example, a transmitter fixedly installed in the field. The electronic unit 3 can also be a portable sensor reading device. The electronic unit 3 has a data memory 4. The electronic unit 3 is suitable for storing the first sensor data S1 of the first electrochemical sensor 2 in the data memory 4. The electronic unit 3 further comprises a communication module 7. The communication module 7 is adapted to be connected to the computing unit 5 and/or a database 6 in order to communicate therewith. The communication between the electronic unit 3 the database 6 and the computing unit 5 are represented schematically in FIG. 1 by double arrows in each case. The communication module 7 is preferably a wireless communication module 7, for example a WLAN, Bluetooth module, or a similar wireless communication module. In an alternative embodiment, the communication module 7 communicates via a cable connection with the database 6 and/or the computing unit 5 (not shown).

The computing unit 5 also has a communication module to be communicatively connected to the electronic unit 3 and/or the database 6. The first sensor data S1 can thus be read out of the data memory 4 of the electronic unit 3 for the computing unit 5. The computing unit 5 is, for example, a PC, server, smartphone or tablet.

The database 6 is, for example, a cloud or a fog. The cloud is preferably designed as a central database, i.e. the database is located on a central server. The fog is preferably designed as a decentralized database, i.e. the database is located on different decentralized servers or storage units. In one embodiment of the present disclosure, the electronic unit 3 can also be connected to the database 6.

The database 6 has second sensor data S2 of second electrochemical sensors 20. In FIG. 1 the second electrochemical sensors 20 are symbolically represented for the second sensor data S2. The second sensor data S2 preferably originate from a plurality of second electrochemical sensors 20.

The second sensor data S2 comprise measured values of a measurement, for example a pH value, a chlorine content, a chlorine dioxide content, a bromine content or an oxygen content of the measured medium. The second sensor data S2 further comprises a history of analyte values, zero point values, impedance values, slope values, asymmetry values, load values, values regarding a remaining service life of the second electrochemical sensors 20, the measurement conditions of the second electrochemical sensors 20, or information regarding the sensor type, such as the design or sensor model, the serial number, the measurement duration, the number of calibration cycles, the service life, the date of production of the sensor, and/or the date of initial start-up of the sensor.

The second sensor data S2 were generated by means of second electrochemical sensors 20 which are structurally identical to the first electrochemical sensor 2. Structurally identical here means that the same sensor type is involved, i.e., for example, an electrochemical pH sensor, and preferably the same sensor model, i.e., for example, a digital electrochemical pH sensor with, for example, a predetermined electrolyte. Preferably, all sensor specifications of the second electrochemical sensors 20 are identical to the first electrochemical sensor 2. The second electrochemical sensors 20 preferably comprise sensors from other users than the user of the first electrochemical sensor 2 i.e. external sensors. The second electrochemical sensors 20 preferably comprise all sensors produced by this sensor model. The second sensor data S2 are preferably anonymised sensor data S2 of the second electrochemical sensors 20. Here, anonymised means that it is not possible to identify a user of the second electrochemical sensors 20 that generated the second sensor data S2 based on the second sensor data S2. In order to realize an ignition efficiently, the second sensor data S2 preferably do not comprise a serial number of the second electrochemical sensors 20 which have produced the second sensor data S2.

The second sensor data S2 were not generated at the same measuring point as the first measuring point 10 by the second electrochemical sensors 20. The second measurement medium in which the second sensor data S2 were generated is different from the first measurement medium 11. This means that it is not the same, i.e. physically and geographically identical, measurement medium. However, it can be a same type of measuring medium which is located at a geographically different location. E.g. the measuring medium can be a waste water of a clarification plant or another measuring medium.

The second sensor data S2 were respectively generated under the same measurement conditions as the measurement conditions under which the first electrochemical sensor 2 produced the first sensor data S1. The term measuring conditions is understood here to mean a specific field of application: for example, use of the sensor in a drinking water installation, clarification plant or industrial plant. Likewise, the measurement conditions, or rather the term measurement conditions is preferably understood to comprise a specific range of measured values: for example, pH values between 5 and 8. The measurement conditions may also comprise other parameters such as temperature of the measured medium, etc.

The computing unit 5 is suitable for reading out and processing the second sensor data S2 from the database 6.

The computing unit 5 is suitable for comparing the first sensor data S1 with the second sensor data S2 and, based on a deviation of the first sensor data S1 from the second sensor data S2, for predicting the remaining service life and/or the next calibration time of the first electrochemical sensor 2.

FIG. 2 shows an exemplary series of second sensor data S2. For example, the series is a development of the remaining life of the second electrochemical sensors 20. The second sensor data S2 comprises sensor data from a plurality of, for example, N-different second electrochemical sensors 20. For the sake of simplicity, the second sensor data of the N-different second electrochemical sensors are represented by the reference symbol SN as representative of all further second sensor data.

FIG. 2 also shows a trend curve K based on all the second sensor data S2, SN. The trend curve K thus illustrates a tendency of the first sensor data S1 to be expected for the first electrochemical sensor 2.

The monitoring procedure of the first electrochemical sensor 2 is discussed below:

In a first implicit step, the monitoring system 1 is provided. This means that the monitoring system 1 is ready for operation. The first electrochemical sensor 2 is in contact with the measuring medium 11 for this purpose.

Then, the first sensor data S1 are generated by the first electrochemical sensor 2 over a first time period. For example, a pH value curve is measured.

The first sensor data S1 are stored in the data memory 4 of the electronic unit 3, or simultaneously with the step of generating the first sensor data S1.

Next, the electronic unit 3 is connected to the computing unit 5. The connection is preferably effected via a wireless connection which is established by the communication module 7 of the electronic unit 3 and the communication module of the computing unit 5. Alternatively, the connection between the electronic unit 3 and the computing unit 5 is established with a cable.

The first sensor data S1 are then read out of the data memory 4 by the computing unit 5. For reading out, the known communication protocols are preferably used in order to guarantee a secure data exchange.

In a next step, the second sensor data S2 are read from the database 6 by the computing unit 5. At this step or thereafter, the computing unit 5 determines a trend curve K defined by the second sensor data S2. The trend curve K is, for example, a polynomial function calculated by the computing unit 5.

Subsequently, the first sensor data S1 are compared with the second sensor data S2 by the computing unit 5. The step of comparing preferably comprises checking whether the second sensor data S2 were actually generated under the same measurement conditions as the first sensor data S1.

In a further step, a deviation of the first sensor data S1 from the second sensor data S2 is determined by the computing unit 5. In this step, a deviation of the first sensor data S1 from the trend curve K is preferably determined.

The prediction about the remaining service life and/or the next calibration time of the first electrochemical sensor 2 is established on the basis of the determined deviation. The next calibration time is based for example on a drift of the zero point values of the sensor. If the course of this drift is stronger for the first sensor data S1 than for the second sensor data S2, the first electrochemical sensor 2 has to be calibrated earlier than the second electrochemical sensors.

In an alternative embodiment of the monitoring method, the electronic unit 3 is connected to the database 6 instead of the computing unit 5. In this embodiment, the first sensor data S1 are sent from the electronic unit 3 to the database 6. In this embodiment as well, the computing unit 5 then reads out the first sensor data S1 from the database 6. All steps described for the previous embodiment are identical to this alternative embodiment. In this embodiment, the first sensor data S1 are identified, for example, by the serial number of the first electrochemical sensor 2 so that the first sensor data S1 can be distinguished from the second sensor data S2.

According to one embodiment of the present disclosure, which is compatible with all previously described embodiments, the next calibration time is indicated as immediately pending when the previously determined deviation has exceeded a first limit value G1 or a second limit value G2. The first limit value G1 and the second limit value G2 are preferably stored in the computing unit 5. The limit value is defined, for example, by a first limit value curve G1 and/or by a second limit value curve G2 which surrounds the trend curve K (see FIG. 2).

The first limit value G1 can also be a maximum tolerable measurement error. If, for example, the first electrochemical sensor 2 is a pH sensor, and if a user has specified 0.1 pH units as the maximum tolerable measurement error, it is checked whether this limit value has been exceeded. For example, if the first electrochemical sensor 2 has an asymmetry of more than 6 mV, this results in a measurement error of 6/59 pH units (>0.1 pH units). In this case, an immediate calibration is therefore necessary.

If a calibration is immediately imminent, an alarm signal is preferably sent to the user through the computing unit 5. The alarm signal is output, for example, directly at the computing unit 5 if the computing unit 5 is a PC, laptop, smartphone or tablet. Alternatively or as complementation, a message, for example an SMS or an e-mail, can also be sent to the user.

According to an embodiment of the present disclosure, which is compatible with all previously described embodiments, if the next calibration time determined by the deviation is further away than a user-specified next calibration time, for example a calibration every 30 days, an extension of the specified next calibration time to the determined next calibration time is suggested. This avoids unnecessary calibrations, which reduces maintenance costs as well as the maintenance effort.

According to an embodiment of the present disclosure, which is compatible with all previously described embodiments, when the next calibration time determined by the deviation is closer away than a user-specified next calibration time, it is proposed to shorten the specified next calibration time to the determined next calibration time. Thus, too late calibrations are avoided and measurement errors are prevented.

1. A monitoring system for an electrochemical sensor, comprising:
a first measuring point having a first measuring medium,
a first electrochemical sensor that is in contact with the first measuring medium and is suitable for generating first sensor data,
an electronic unit which is connected to the first electrochemical sensor and has a data memory,
the electronic unit being suitable for storing the first sensor data generated by the first electrochemical sensor in the data memory, a computing unit adapted to be connected to the electronic unit for reading out the first sensor data in the data memory,
the computing unit being connected to a database and the database having second sensor data of second electrochemical sensors,
the second electrochemical sensors being structurally identical to the first electrochemical sensor,
the second sensor data being generated by the second electrochemical sensors at second measuring points different from the first measuring point in second measuring media different from the first measuring medium,
wherein the computing unit is suitable for comparing the first sensor data with the second sensor data and, based on a deviation of the first sensor data from the second sensor data, for predicting the remaining service life and/or the next calibration time of the first electrochemical sensor.

2. The monitoring system according to claim 1, wherein the database is a central cloud or a decentralized fog and the second sensor data is anonymised.

3. The monitoring system according to claim 1, wherein the second electrochemical sensors are external sensors.

4. The monitoring system according to claim 1, wherein the first electrochemical sensor is a pH sensor, a disinfection sensor or a dissolved oxygen sensor.

5. The monitoring system according to claim 1, wherein the second sensor data were generated in each case under the same measurement conditions as the measurement conditions under which the first electrochemical sensor produced the first sensor data.

6. The monitoring method of an electrochemical sensor comprising the following steps:
providing a monitoring system according to claim 1,
generating first sensor data by the first electrochemical sensor,
storing the first sensor data in the data memory of the electronic unit,
connecting the electronic unit to the computing unit,
reading out the first sensor data from the data memory through the computing unit,
reading out the second sensor data from the database through the computing unit,
comparing the first sensor data with the second sensor data through the computing unit,
determining a deviation of the first sensor data from the second sensor data through the computing unit,
generating a prediction of the remaining service life and/or the next calibration time of the first electrochemical sensor on the basis of the determined deviation through the computing unit.

7. The monitoring method according to claim 6, wherein first sensor data and second sensor data comprise a history of analyte values, zero point values, slope values, asymmetry values, impedance values, load values or residual lifetime.

8. The monitoring method of an electrochemical sensor comprising the following steps:
providing a monitoring module according to claim 1;
generating first sensor data by the first electrochemical sensor,
storing the first sensor data in the data memory of the electronic unit,
connecting the electronic unit to the database,
sending the first sensor data from the electronic unit to the database,
reading out the first sensor data from the database through the computing unit,
reading out the second sensor data from the database through the computing unit,
comparing the first sensor data with the second sensor data through the computing unit,
determining a deviation of the first sensor data from the second sensor data,
establishing a prediction of the remaining service life or the next calibration time of the first electrochemical sensor based on the determined deviation.

9. The monitoring method according to claim 6, wherein the next calibration time is indicated as immediately pending when the deviation exceeds a first limit value.

10. The monitoring method according to claim 6, wherein if the next calibration time determined by the deviation is further away than a next calibration time specified by the user, an extension of the predetermined next calibration time to the determined next calibration time is suggested.
